(19) United States
(12) Patent Application Publication
(10) Pub. No.: US 2009/0155748 A1
(43) Pub. Date: Jun. 18, 2009

(54) EDUCATIONAL BOARD GAME

(76) Inventor: James Earl HUSKEY, Copperhill, TN (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/334,158

(22) Filed: Dec. 12, 2008

Related U.S. Application Data
(60) Provisional application No. 61/013,170, filed on Dec. 12, 2007.

(51) Int. Cl. G09B 19/22

(52) U.S. Cl. 434/128

(57) ABSTRACT

An educational board game for students to play while learning information. The board game includes a game board and playing chips. The game board includes a rectangular grid-like playing field that incorporates ten individual zones. Each zone incorporates ten numbered boxes, such that the playing field includes 100 boxes labeled from 0-99. Each playing chip corresponds to at least one box within the playing field.

### CROSS-REFERENCE TO RELATED APPLICATION

This application claims priority to U.S. Provisional Patent Application Ser. No. 61/013,170, filed Dec. 12, 2007, entitled “METHOD AND APPARATUS FOR LEARNING INFORMATION, which is incorporated herein by reference in its entirety.

### TECHNICAL FIELD

The present invention relates generally to games, and more particularly, to an interactive educational board game.

### BACKGROUND OF THE INVENTION

It is often difficult for parents and teachers alike to motivate students in an educational environment—especially at an early age when a child's attention span is limited. Not surprisingly, parents and teachers often fight with athletics, board or video games, and other extracurricular activities for a student's attention. Therefore, it has become widely accepted for teachers and parents to utilize games to motivate students to learn. In fact, many educational games are used to promote learning in students. Games are often successful in educating students because the students do not realize that he/she is actually learning; rather, the students playing the game simply enjoy doing so. Games can be especially helpful when the subject matter is difficult for students to understand conceptually, such as mathematics, and offer the student a visual guide to reinforce such subjects. In addition, it is widely known that games stimulate competition that often drives people to excel. However, most known educational games are limited to a particular topic or subject matter and are limited in scope. For instance, a user may have to purchase an individual educational game for each topic or subject of interest. Also, educational board games often only include a limited set of knowledge (e.g. as in a limited number of game cards) that can be learned by the student, at which time additional games or components must be obtained.

Thus, it can be seen that needs exist for an educational game that is expansive in scope and that can be used for a wide variety of subjects. It is to the provision of these needs and others that the present invention is primarily directed.

### SUMMARY OF THE INVENTION

The present invention relates to an educational board game for students of all ages. The board game allows students to enjoy learning by encouraging friendly competition and by encouraging learning to be fun. Additionally, the board game of the present invention is expandable, such that players can create their own questions and answers while still using the game board of the present invention. Still further, the board game of the present invention helps children develop learning skills, such as working with colors, numbers, and words at an early age. In fact, the present invention forces students to learn by association.

In one aspect, the present invention relates to an educational board game for students to play while learning information. The board game includes a game board and playing chips. The game board includes a rectangular grid-like playing field that incorporates ten individual zones. Each zone incorporates ten numbered boxes, such that the playing field includes 100 boxes labeled from 00-99. Each playing chip corresponds to at least one box within the playing field.

In another aspect, the present invention relates to an educational board game including a game board having a rectangular grid-like playing field and a plurality of chips. The playing field incorporates ten zones, with each zone having three columns and four rows of boxes. Each box is designated by a number between 00 and 99. The plurality of chips correspond to a particular box and each chip also corresponds to a number between 00 and 99.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a schematic description of the upper face of a board game according to an example embodiment of the present invention.

FIG. 2 is a schematic description of the upper face of the board game of FIG. 1, shown with playing chips.

FIG. 3A is a schematic view of a colored chip design according to an example embodiment of the present invention.

FIG. 3B is a schematic view of a colored chip design according to another example embodiment of the present invention.

FIG. 3C is a schematic view of a chip design according to still another example embodiment of the present invention.

FIG. 3D is a schematic view of a chip design according to another example embodiment of the present invention.

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

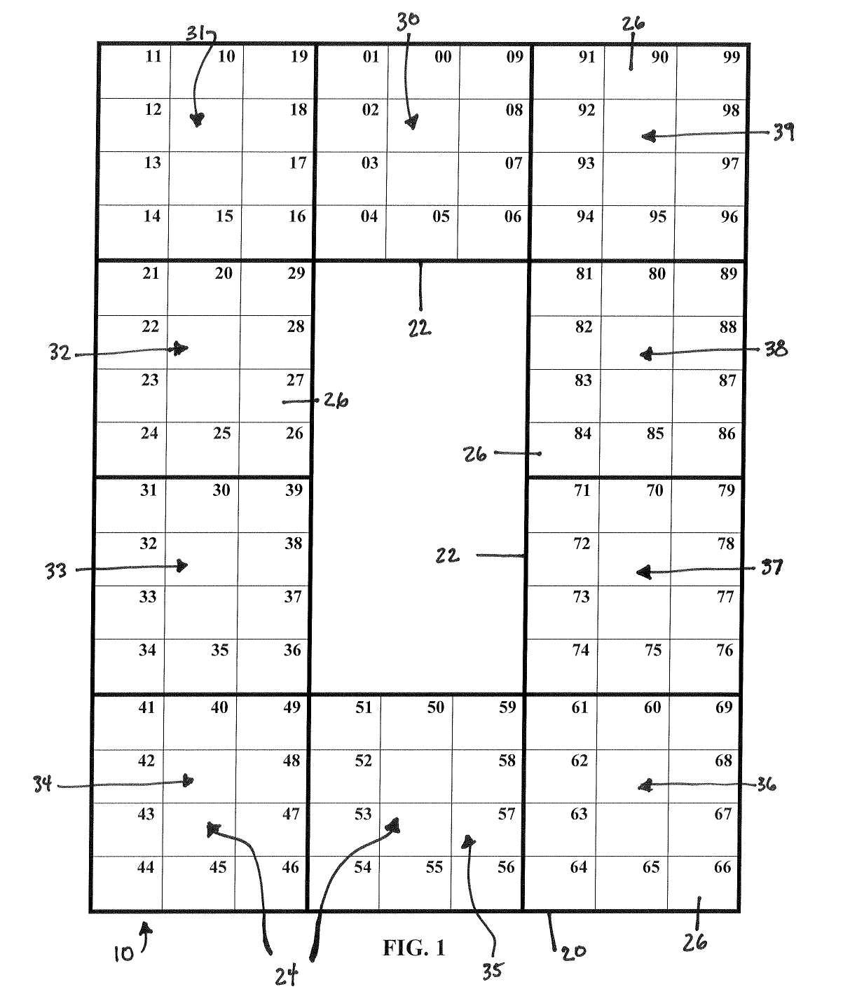

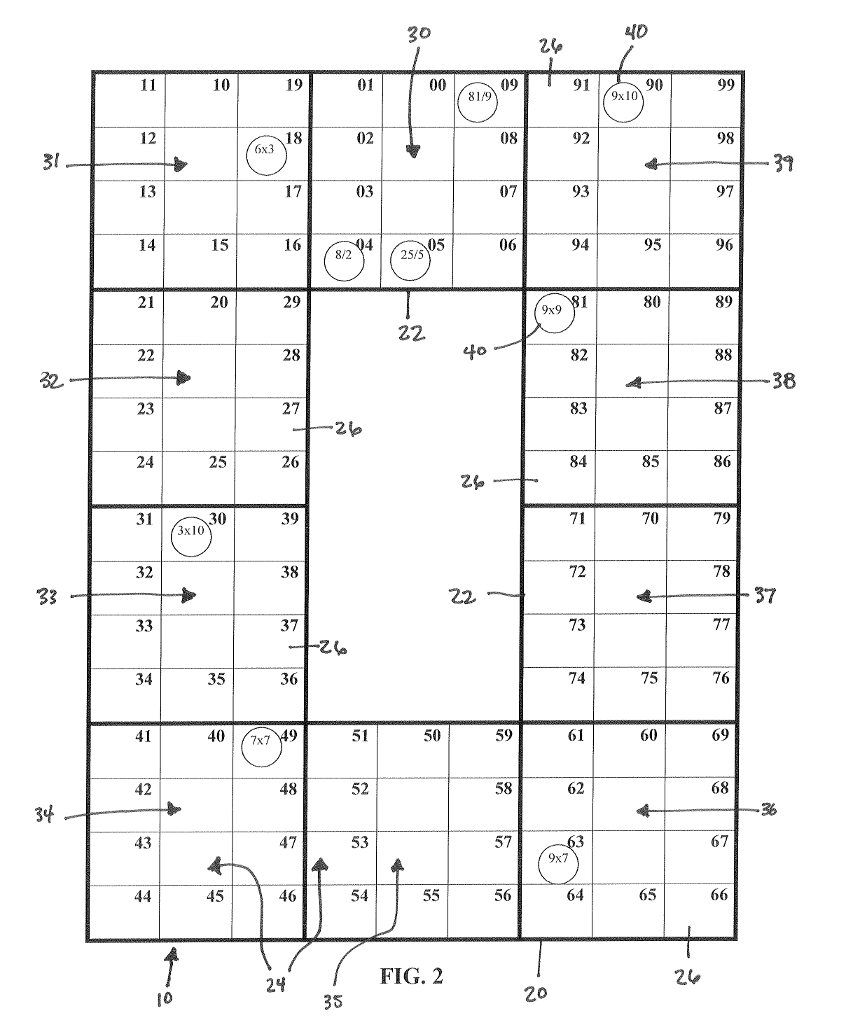

With reference now to the drawing figures, FIGS. 1-2 show an example embodiment of a board game 10 according to the present invention. As shown in FIG. 1, the board game 10 consists of a planar sheet 20 depicting a rectangular grid-like playing field 22 thereon. In depicted example embodiments, the playing field 22 includes ten individual zones 24, individually referenced as 30, 31, 32, 33, 34, 35, 36, 37, 38, and 39. In other example embodiments, the playing field 22 includes at least one zone 24. In still other example embodiments, the playing field 22 includes more than ten zones 24. In other example embodiments, the playing field 22 can include as many zones as desired by a player. Alternatively, players can connect sheets 20 together to create a matrix to suit the individual interests of the player. In this regard, there is no limit to how many sheets 20 can be connected together to form the playing field 22. Referring again specifically to FIG. 1, it can be seen that in example embodiments each individual zone 24 includes twelve rectangular boxes 26 (reference no. 26 refers to boxes generally), of which ten incorporate numerals. In example embodiments, the playing field 22 is numbered from 00-99 (one hundred total numbered boxes 26), wherein each successive zone 24 includes ten successive numerals. For example, it can be seen in FIG. 1, that zone 30 is numbered from 00-09, zone 31 is numbered from 10-19, zone 32 is numbered from 20-29, etc. such that zone 39 is numbered from 90-99 (again demonstrating that example embodiments of the present invention include a playing field incorporating one hundred total boxes 26). In alternative embodiments, the number of boxes 26 can be more or fewer depending on the player's desire. In preferred embodiments of the present invention, each zone 24 is identified by the first integer common to all box 26 numbers within each zone, and the particular box within the zone is identified by the second integer. For example, box number “29” (located within reference zone 32) is in zone “2” and box number “07” (located within reference zone 30) is in zone “0”. The planar sheet 20 can be formed from cardboard, paper, wood, tile, metal (particularly, but not limited to, ferromagnetic metal), and/or other materials as desired.

The board game 10 of the present invention also incorporates playing chips 40 as seen in FIG. 2. In example embodiments the playing chips 40 are preferably round, but can alternatively be rectangular, elliptical, triangular, or otherwise shaped. The chips 40 can be formed from cardboard, paper, wood, plastic, metal, ceramics, or can be magnets (or comprise magnets). In commercial embodiments, the chips 40 are formed from plastic. In still other example embodiments, the chips 40 can be modeled to look like airplanes, boats, trains, animals, golf tees, people or otherwise as desired. Each chip 40 is imprinted with a piece of information (e.g. a question or answer to a question) that is used to pair the chip with an appropriate box 26 within the playing field 22. For example in FIG. 2, each chip is shown imprinted with a mathematical computation, such as “3×10” or “25/5”. In alternative embodiments, the playing chips 40 are colored (single or multi-colored). In other embodiments, the playing chips include letters of the alphabet or numerals. Each board game 10 comes packaged with a plurality of chips 40 to allow a player to begin playing immediately upon receiving the game. Additionally, players can create their own chips as desired, such that the game 10 has an infinite number of possible chips that can be utilized with a single (or multiple) playing sheet(s).

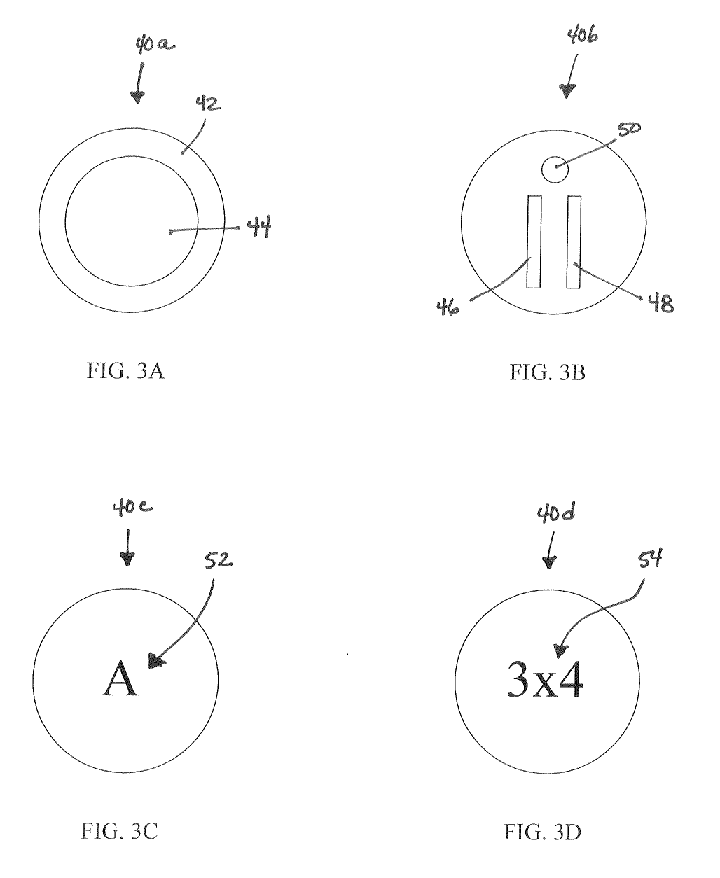

Several types of playing chips 40 that can be utilized with the board game 10 of the present invention are seen in FIGS. 3A-3D. For example, FIG. 3A depicts a design for a colored chip 40a. Chip 40a includes two sections: a rim section 42 and a middle section 44. The colored chip 40a utilizes a system wherein each color corresponds to a number. For example, in example embodiments, “0” corresponds to black, “1” corresponds to brown, “2” corresponds to red, “3” corresponds to orange, “4” corresponds to yellow, “5” corresponds to green, “6” corresponds to blue, “7” corresponds to violet, “8” corresponds to gray, and “9” corresponds to white. Each chip 40a therefore represents two numbers: the rim section 42 color representing the first number, and the middle section 44 representing the second number. For instance, a chip having a rim section 42 color that is orange and a middle section 44 color that is blue would represent the number “36”. Similarly, a chip having a rim section 42 that is yellow in color and a middle section 44 that is green in color would represent the number “45”. FIG. 3B depicts another example embodiment of a chip 40b. In this embodiment the chip 40b includes a first colored line 46, a second colored line 48 and dot 50 that represents the top of the chip 40b. As with chip type 40a, the first line represents the first number and the second line represents the second number (read from left to right viewing the chip 40b with the dot 50 at the top of the chip). Thus, chip 40b having a first line 46 colored red and a second line 48 colored green would represent “25”.

FIG. 3C depicts still another chip design 40c that includes a letter of the alphabet 52 on the face. The chip 40c corresponds to the box number 26 of the playing field 22 that equals the number of the letter's order in the alphabet, such that “A” represents the first letter in the alphabet and would thus corresponds to box “01” (located in reference zone 30). When using the type of chips depicted in FIG. 3C, it is anticipated that only box numbers “1-26” will be used as there are only 26 letters in the alphabet.

FIG. 3D shows a close-up view of the chips 40d used in FIG. 2, having a mathematical computation 54 imprinted on the face of the chips.

To play the game in one example embodiment—in specific reference to FIG. 2—a player can start with a collection of chips 40d imprinted with mathematical computations 54. The player can play by himself/herself, can utilize a timer (not shown), or can compete against other players to see who can correctly place all the chips on the playing field 22 first. Once the game begins, each individual player picks up chips 40 in succession and places them on the playing field 22 within the correct box 26. For example, if a player picks up a chip inscribed with “9×10”, the player would need to place the chip in the box 26 having the numeral “90” (which is located within zone 39), and if the next chip the player picks up is inscribed with “8/2”, the player would need to place the chip in the box 26 having the numeral “4” (which is located within zone 30). The player to correctly place all of his/her chips 40 onto the playing field 22 wins.

In other example embodiments a player can match colored chips 40a (or 40b) to the appropriate boxes 26 on the playing field 22. For example, a player who gets a chip 40a (or 40b) having a black rim 42 and blue center 44 (or a first black line 46 and second blue line 48) would place the chip in box number “06” (located in reference zone 30). A player can practice by himself/herself or can compete against others to see which player can correctly place the chips 40 on the playing field 22 in a specified period of time.

In still other embodiments, a player can spell words with chips 40c by placing each chip on the corresponding box 26 in the playing field 22. For example, to spell “BOY” a player would place a chip 40c inscribed with the letter “B” on box number “2”, a chip with the letter “O” on box number “15” and a chip with the letter “Y” on box number “25”. Players can challenge themselves further by using colored chips 40a or 40b to spell words. In this regard, a player would spell “BOY” by locating a chip with a white rim 42 (or white first line 46) and a red middle section 44 (or red second line 48)—indicating the number “2”—and place that chip on box number “2”, etc.

In fact, there are an endless number of ways that a player can play the board game 10 of the present invention. For example, the playing field 22 can include slots (now shown) for receiving chips 40 therein, such that only certain chips can fit into certain slots. Thus, the above referenced examples are only a representative sample of the ways the board game 10 can be utilized to effect learning in students. Nothing herein is intended to limit the board game 10 of the present invention to the samples depicted and discussed.

While the invention has been described with reference to preferred and example embodiments, it will be understood by those skilled in the art that a variety of modifications, additions and deletions are within the scope of the invention, as defined by the following claims.

1. An educational board game comprising:
a game board having a rectangular grid-like playing field, the playing field incorporating ten individual zones and each zone incorporating ten numbered boxes, such that the playing field includes 100 boxes labeled from 0 to 99; and
a plurality of chips, each corresponding to at least one box within the playing field.

2. The educational board game of claim 1, wherein each chip is imprinted with a question.

3. The educational board game of claim 2, wherein the answer to each question imprinted on each chip is located within a box in the playing field.

4. The educational board game of claim 1, wherein each chip is imprinted with a mathematical computation.

5. The educational board game of claim 4, wherein the answer to the mathematical computation is a whole integer between 0 and 99.

6. The educational board game of claim 1, wherein the chips are partially colored.

7. The educational board game of claim 6, wherein the chips include a rim section and a middle section, wherein the rim section and middle section are colored.

8. The educational board game of claim 7, wherein the outer section color refers to a first number and the middle section color refers to a second number, such that the chip represents a number between 00-99.

9. The educational board game of claim 6, wherein chips includes a first line representing a first number and a second line representing a second number.

10. An educational board game comprising:
a game board having a rectangular grid-like playing field, the playing field incorporating ten zones, each zone having three columns and four rows of boxes;
a plurality of chips that each correspond to a particular box;
wherein each box is designated by a number between 00 and 99 and each chip corresponds to a number between 00 and 99.
